(19) United States
(12) Patent Application Publication
(10) Pub. No.: US 2026/0342164 A1
(43) Pub. Date: Oct. 29, 2026

(54) STATOR

(71) Applicant: Schaeffer Technologies AG & Co., KG, Herzogenaurach (DE)

(72) Inventors: Sven DERKSEN, Offenburg (DE); Valentin Lehner, Karlsruhe (DE); Michael Marsetz, Ettlingen (DE)

(73) Assignee: Schaeffer Technologies AG & Co., KG, Herzogenaurach (DE)

(21) Appl. No.: 19/119,545

(22) PCT Filed: Sep. 12, 2023
(86) PCT No.: PCT/DE2023/100672

§ 371 Date: Apr. 9, 2025

(30) Foreign Application Priority Data
Oct. 12, 2022 (DE) 10 2022 126 516.1

(51) Int. Cl. H02K 3/50; H02K 1/16

(52) U.S. Cl. CPC H02K 3/50; H02K 1/16; H02K 2203/09

(57) ABSTRACT

The disclosure relates to a stator of an electric machine, in particular for a drivetrain of a motor vehicle, comprising a stator element having an energizable winding which is electrically conductively connected to a plurality of busbars extending outside the stator element, wherein a cable channel formed from electrically nonconductive plastics material is arranged on the busbars and has at least one busbar fixing means by which the cable channel is fixed to the busbars and the position of the busbars relative to one another is fixed.

### CROSS-REFERENCE TO RELATED APPLICATIONS

This application is the U.S. National Phase of PCT Appln. No. PCT/DE2023/100672, filed Sep. 12, 2023, which claims the benefit of German Patent Appln. No. 102022126516.1, filed Oct. 12, 2022, the entire disclosures of which are incorporated by reference herein.

### TECHNICAL FIELD

The present disclosure relates to a stator of an electric machine, in particular for a drivetrain of a motor vehicle, comprising a stator element with an energizable winding which is electrically conductively connected to a plurality of busbars extending outside the stator element.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort which they are accustomed to.

A detailed description of an electric drive can be found in an article in the German automotive magazine ATZ, volume 113, 05/2011, pages 360-365 by Erik Schneider, Frank Fickl, Bernd Cebulski and Jens Liebold with the title: “Hochintegrativ und flexibel—Elektrische Antriebseinheit für E-Fahrzeuge” [Highly Integrative and Flexible—Electric Drive Unit for Electric Vehicles], which is probably the closest prior art. This article describes a drive unit for an axle of a vehicle, which comprises an electric motor arranged concentrically and coaxially to a bevel gear differential. Such drive units are also referred to as e-axles or electrically operable drivetrains.

Permanently excited synchronous machines (PSM) are already used in many industrial applications and, in the course of electrification, increasingly also in the automotive industry. Such a permanently excited synchronous machine usually has a stator to be energized and a permanently excited rotor. The stator comprises, among other things, a stator winding, a stator carrier, an interconnection ring, and a terminal for the power electronics unit.

Electric machines with distributed winding or wave winding usually have an interconnection region in which different conductors of the winding are connected to one another. This coupling is also referred to as a bridge, which is usually responsible for reversing the direction of the current flow. Furthermore, the interconnection can also contain a so-called star point or star phase. At this point, all conductors and currents of the different phases flow together according to a star connection. As a further component, the electric machine has a high-voltage terminal. This component is responsible for the power supply of the electric machine via the power electronics unit.

High-voltage terminals with an integrated interconnection region have become known from the prior art. For example, DE 10 2019 111 825 A1 discloses a stator for an electric machine having such a high-voltage terminal. Likewise, from DE 10 2018 119 831 A1, an electric machine comprising a stator with concentrated windings arranged on stator teeth and comprising at least one temperature sensor for detecting the temperature of a winding is already known. Here, a stator component is designed as an interconnection ring, which carries one or more metal wiring conductor rings, for example.

Furthermore, a contacting device for electrically connecting the wiring wire ends of the stator windings to contact connections of a power electronics unit is known from US 2019/0372422 A1, in which the corresponding conductor ends to be connected are electrically connected to one another by means of a press connection.

Such interconnection areas between a power electronics unit and the winding wire ends are usually formed by means of so-called busbars. These are usually dimensionally stable busbars with a contour necessary for wiring and contacting. If such busbars are relatively long compared to their cross-section due to the system design, they have a relatively high susceptibility to vibration. In such cases, they usually have to be stiffened to avoid damage to the component itself or adjacent components. In order to fix or couple the busbars together, it is known to overmold them for reinforcement. However, such busbars often already have a coating, which makes them very difficult or even impossible to overmold.

### SUMMARY

Although such components are known from the prior art, there is still a desire to optimize them. Furthermore, it is an object of the present disclosure to provide a stator that is improved in relation to the prior art.

This object is achieved by a stator of an electric machine, in particular for a drivetrain of a motor vehicle, comprising a stator element with an energizable winding which is electrically conductively connected to a plurality of busbars extending outside the stator element, wherein a cable channel formed from electrically nonconductive plastics material is arranged on the busbars and has at least one busbar fixing means by which the cable channel is fixed to the busbars and the position of the busbars relative to one another is fixed.

Instead of overmolding the busbars, as is known from the prior art, a separately manufactured cable channel is mounted on the busbars according to the disclosure. This results in a number of advantages, for example easier assembly, since fewer components have to be assembled and a bundled joining process with a preferred axial joining direction of the cable channel relative to the stator can be realized. Furthermore, a structurally rigid and robust fixing of the busbars through the cable channel can be achieved due to the coupling of the individual fixings and the cross-sectional contour of the cable channel.

Furthermore, any bending tolerances that arise can be compensated, meaning that the cable channel can also function as a positioning aid during the welding process of the individual wires of the stator winding. The cable channel can also serve as transport security during handling and logistics of the stator, so that sensitive component tolerances of the wire ends can be stabilized.

The stator according to the disclosure thus has a cable channel with integrated busbar fixation. The cable channel can, for example, accommodate the electrical cables of a sensor, such as a temperature sensor. This allows the cable routing of such a temperature sensor cable and the busbar fixation to be optimized in terms of robustness, installation handling and costs.

The cable channel is preferably designed as a plastic injection-molded component.

First, the individual elements of the claimed subject matter of the disclosure are explained in the order of their relevance or their mention in the claims, and then particularly preferred embodiments of the subject matter of the disclosure are described.

Electric machines are used to convert electrical energy into mechanical energy and/or vice versa, and generally comprise a stationary part referred to as a stator or stationary armature, and a part referred to as a rotor or moving armature and arranged movably relative to the stationary part.

In the case of electric machines designed as rotary machines, a distinction is drawn in particular between radial flux machines and axial flux machines. A radial flux machine is characterized in that the magnetic field lines extend in the radial direction in the air gap formed between rotor and stator, while in the case of an axial flux machine the magnetic field lines extend in the axial direction in the air gap formed between rotor and stator. Particularly preferably, in connection with the present disclosure, the electric machine is configured as a radial flux machine.

The stator of a radial flux machine usually has a cylindrical structure and generally consists of electrical laminations that are electrically insulated from one another and are structured in layers and packaged to form laminated cores. Distributed over the circumference, grooves or circumferentially closed recesses are embedded into the electrical lamination extending parallel to the rotor shaft, and accommodate the stator winding or parts of the stator winding. Depending on the construction towards the surface, the grooves can be closed with closing elements, such as closing wedges or covers or the like, to prevent the stator winding from detaching.

A stator winding is an electrically conductive conductor which has a longitudinal extension that is much greater than its diameter. The stator winding can generally have any cross-sectional shape. Rectangular cross-sectional shapes are preferred, as these allow for high packing densities and consequently high power densities to be achieved. Particularly preferably, a stator winding is formed of copper. Preferably, a stator winding has insulation. To insulate the stator winding, for example, mica paper, which for mechanical reasons can be reinforced by a glass fabric backing, may be wound in tape form around one or more stator windings, which are impregnated by means of a curing resin. In principle, it is also possible to use a curable lacquer layer without mica paper to insulate a stator winding.

The stator winding can be designed as a distributed winding or as a concentrated winding.

In an electric machine with concentrated windings, the interconnection of the individual windings distributed around the circumference can, for example, be achieved by means of an interconnection ring or several interconnection rings.

Here, busbars usually made of copper can be arranged on or in a common carrier ring or separate carrier rings made of plastic, which are also known as a high-voltage terminal. On occasion, this type of interconnection ring has also been referred to as a “switching ring” or “contact bridge”. Interconnection rings of this type are usually placed axially on the winding package.

The stator may include a high-voltage terminal. A high-voltage terminal can accommodate one or more busbars and, in particular, arrange them at a distance from one another in an electrically insulating manner. As a rule, a high-voltage terminal has a circular ring or circular ring section-like basic shape with several circular ring/circular ring section-shaped and concentrically arranged receptacles, such as grooves, in which the corresponding busbars are arranged. Preferably, a high-voltage terminal is made of an electrically nonconductive plastic material. In principle, it is conceivable to design a carrier ring in one piece or in several pieces.

The electric machine can therefore preferably have a sensor which is connected in particular to a control device of the electric machine. The electrical conductors of the sensor can preferably be routed in the cable channel. Preferably, the sensor is designed as a temperature sensor.

In this context, a control device is understood to mean a control unit for controlling the electric machine for the purpose of operating it. The control unit can particularly preferably comprise a power electronics module for energizing the stator or rotor. A power electronics module is preferably a combination of various components that provide open-or closed-loop control of a current to the electrical machine, preferably including peripheral components required for this, such as cooling elements or power supply units. In particular, the power electronics module contains a power electronics unit or one or more power electronics unit components that are configured to provide open-or closed-loop control of a current. These are particularly preferably one or more power switches, such as power transistors. The power electronics unit particularly preferably has more than two, particularly preferably three, phases or current paths which are separate from one another and each have at least one separate power electronics unit component. The power electronics unit is preferably designed to provide an open-or closed-loop control of a power per phase with a peak power, preferably continuous power, of at least 10 W, preferably at least 100 W, particularly preferably at least 1000 W.

A control device of the electric machine is used for the, in particular electronic open- or closed-loop control of one or more technical systems of the motor vehicle. In particular, a control device can be provided for the open- or closed-loop control of the electric machine.

The busbars can preferably have a rectangular cross-section. Most preferably, the busbars are made of copper. It is also possible that the busbars have a plastic coating. Preferably, the plastic coating is made of an electrically nonconductive plastic.

Further advantageous embodiments of the disclosure are specified in the dependent claims. The features listed individually in the dependent claims can be combined with one another in a technologically meaningful manner and can define further embodiments of the disclosure. In addition, the features indicated in the claims are specified and explained in more detail in the description, wherein further preferred embodiments of the disclosure are shown.

According to an advantageous embodiment of the disclosure, it can be provided that the cable channel has a substantially U-shaped contour in cross section with two parallel channel side walls and a channel base. The advantage of this design is that the U-shape allows a cable channel to be designed with particularly high mechanical rigidity, which can also be easily implemented using injection molding or tooling technology.

According to a further preferred development of the disclosure, it can also be provided that at least one cable clamp is arranged on at least one of the channel side walls, which secures a cable extending in the cable channel against exiting from the cable channel by narrowing the opening cross-section of the cable channel at least in sections. This allows for improved and safer cable routing within the cable channel.

Furthermore, according to a likewise advantageous embodiment of the disclosure, it can be provided that the busbar fixing means have at least one busbar spacer element, against which two adjacent busbars rest and which is formed integrally with the channel base and extends out of the channel base in the direction of the busbars. The advantageous effect of this design is based on the fact that the busbars can be fixed to one another in one assembly step together with the plugging-in of the cable channel.

According to a further particularly preferred embodiment of the disclosure, it can be provided that the channel base rests on the busbars, whereby a defined end position of the cable channel can be achieved when it is plugged onto the busbars as well as a particularly robust fixing of the busbar positions.

Furthermore, the disclosure can also be further developed in such a way that a retaining element is arranged on the free end of the busbar spacer element, that engages behind and/or around two adjacent busbars at least in sections, so that the cable channel is held securely against the busbars. In a likewise preferred embodiment variant of the disclosure, it can also be provided that the retaining element is formed integrally, in particular monolithically, with the busbar spacer element, which is particularly favorable in terms of manufacturing technology and thus also in terms of costs. In this context, it may also be advantageous to further develop the disclosure in such a way that the retaining element is formed by hot caulking the busbar spacer element. The advantage that can be achieved in this way is that no separate retaining element needs to be provided and installed, which brings corresponding advantages both in terms of manufacturing and assembly.

According to a further preferred embodiment of the subject matter of the disclosure, however, it can in principle also be provided that the busbar fixing means comprise a separate retaining element. A separate retaining device can be, for example, a cable tie or a locking clip.

Finally, the disclosure can also be advantageously designed in such a way that the cable channel has a Z-shaped profile in the longitudinal direction. The main advantage of this is that the Z-shaped contour provides strain relief for a cable extending in the cable channel.

### BRIEF DESCRIPTION OF THE DRAWINGS

The disclosure is explained in more detail below with reference to figures without limiting the general concept of the disclosure.

In the drawings:

FIG. 1 shows a motor vehicle with an electric drivetrain in a schematic block diagram,

FIG. 2 shows an electric machine in a schematic cross-sectional view,

FIG. 3 shows a first embodiment of a cable channel in the state placed on the busbars in a perspective and a cross-sectional view,

FIG. 4 shows a second embodiment of a cable channel in the state placed on the busbars in a perspective and a cross-sectional view,

FIG. 5 shows a third embodiment of a cable channel in the state placed on the busbars in a perspective and a cross-sectional view,

FIG. 6 shows a fourth embodiment of a cable channel in the state placed on the busbars in a perspective and a cross-sectional view,

FIG. 7 shows a fifth embodiment of a cable channel in the state placed on the busbars in a perspective and a cross-sectional view.

### DETAILED DESCRIPTION

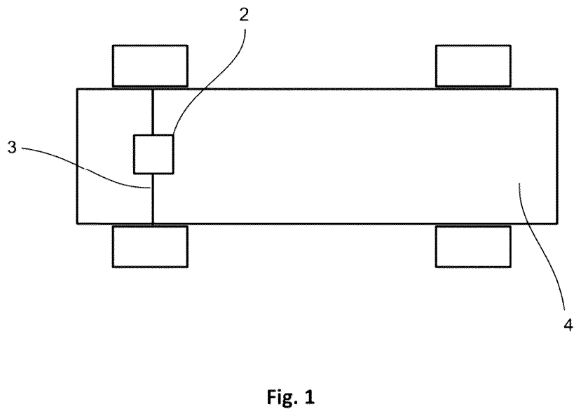

The disclosure is explained using a stator 1 of an electric machine 2 for a drivetrain 3 of a motor vehicle 4, as shown by way of example in FIG. 1.

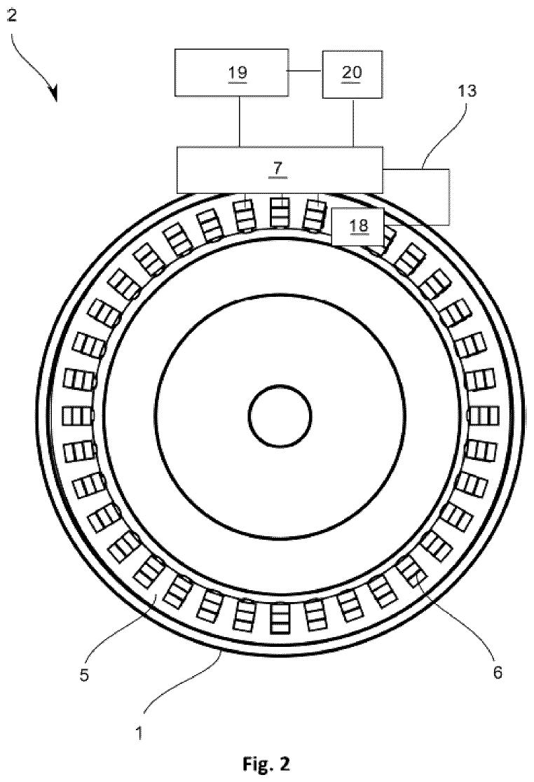

As can be seen from FIG. 2, the stator 1 comprises a stator element 5 with an energizable winding 6, which is electrically conductively connected to a plurality of busbars 7 extending outside the stator element 5. The busbars 7 are also connected to the power electronics unit 19 for energizing the winding 6. Furthermore, a temperature sensor 18 for monitoring the stator and/or winding temperature is arranged on or in the stator 1, wherein the temperature sensor 18 is connected to the control unit 20.

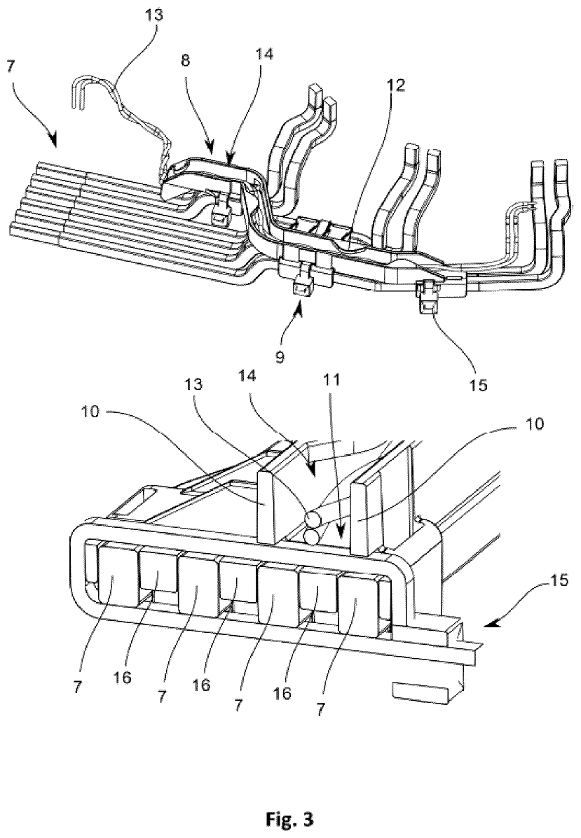

As can be seen from FIGS. 3-7, a cable channel 8 formed from an electrically nonconductive plastics material is arranged on the busbars 7, which has at least one busbar fixing means 9, by which the cable channel 8 is fixed to the busbars 7 and the position of the busbars 7 relative to one another is fixed. The cable channel 8 has a substantially U-shaped contour in cross-section with two parallel channel side walls 10 and a channel base 11.

Tab-like cable clamps 12 are arranged on the channel side walls 10, which secure a cable 13 extending in the cable channel 8 against exiting from the cable channel 8 by narrowing the opening cross-section 14 of the cable channel 8 at least in sections. In the examples shown, the tab-like cable clamps 12 are arranged alternately on the channel side walls 10 over the longitudinal extent of the cable channel 8.

As a result, the cable 13 of the temperature sensor 18 is guided within the cable channel 8, which is also referred to as “routing.” The cable(s) 13 are laid through the upper opening cross-section 14 of the U-profile of the cable channel 8 and are fixed and secured against loss within the cable channel 8 via the cable clamps 12. When inserting the cables 13, a certain assembly force is required so that the cables 13 slip through the opening cross-section 14 and then return to their normal position. In the embodiments shown, the cable channel 8 has a Z-like course in its longitudinal extension, whereby a corresponding Z-shaped cable routing is formed and a strain relief for the cables 13 can be realized.

In addition to the function of cable routing in the cable channel 8, this can contribute to a reinforcement of the busbars 7, which is explained in more detail below. The busbars 7 are connected and fixed to the cable channel 8 at several coupling points. The assembly is carried out as a combination of force-and/or form-fitting and can be carried out as shown in the different versions in FIGS. 3-7.

All of these embodiments of FIGS. 3-7 have in common that the busbar fixing means 9 have a plurality of busbar spacer elements 16, against which two adjacent busbars 7 rest and which are integrally formed with the channel base 11 and extend out of the channel base 11 in the direction of the busbars 7. As can be seen from FIGS. 3-7, this results in a comb-like configuration of the busbar spacer elements 16 in cross section, between which the busbars 7 then extend and rest. The channel base 11 rests on the busbars 7.

In the embodiments shown, the cable channel 8 is secured at three positions spaced apart in the longitudinal extension of the cable channel 8 by the respective busbar spacer elements 16 and the retaining elements 15 relative to the total of six busbars 7. In these retaining areas of the cable channel 8, the busbars 7 run parallel and in a common plane, which can also be clearly seen from the cross-sectional views in FIGS. 3-7.

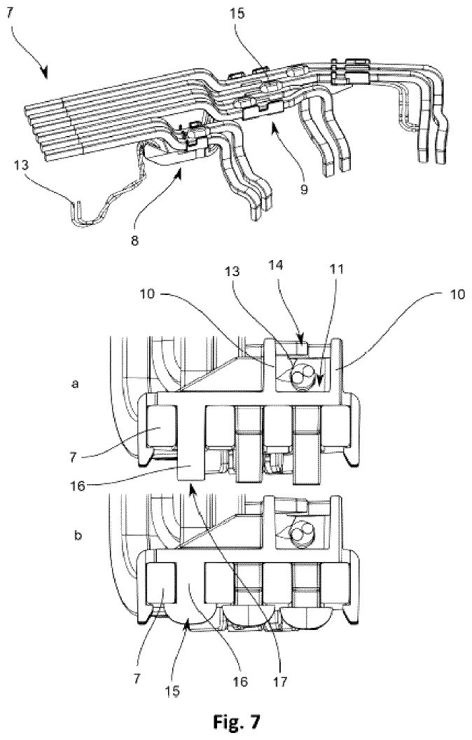

Form-locking means, for example locking means, can be provided on the outer edge regions in the transverse extension of the cable channel 8, which ensure an exact positioning of the cable channel 8 relative to the busbars 7. These locking means, which are monolithically formed with the cable channel 8, can be seen particularly well in FIG. 7. This means that the cable channel 8 can be form-fittingly secured against loss in relation to the busbars 7 as soon as it is fitted.

It is also clear from FIGS. 3-6 that the busbar fixing means 9 can comprise a separate retaining element 15. In the embodiment shown in FIG. 3, the retaining element 15 is formed as a cable tie which encompasses the cable channel 8 and the busbars 7 in cross section and thus secures them against each other.

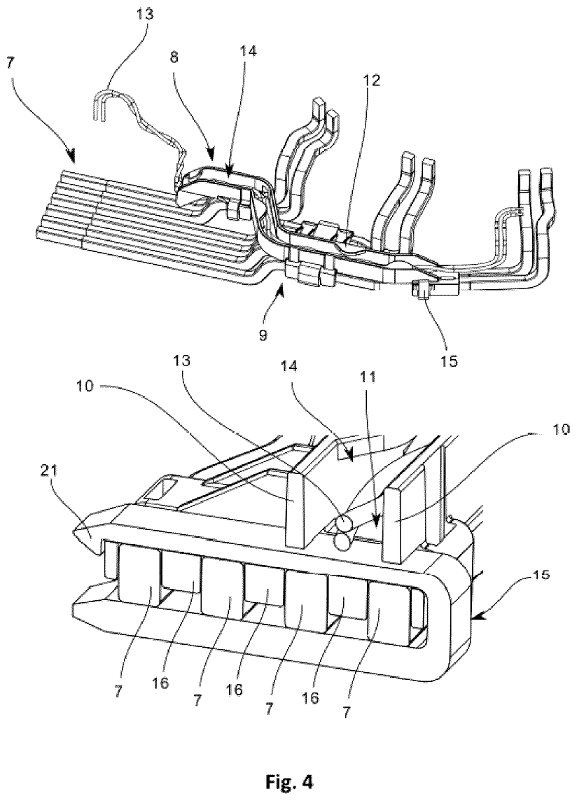

FIG. 4 shows an alternative variant in which the retaining element 15 is designed as a clamp. A latching lug 21 is formed on a free leg of the U-shaped retaining element 15, which latches with the cable channel 8 in a direction transverse to the longitudinal extension of the cable channel 8 after the clip has been pushed onto the cable channel 8 or onto the busbars 7. In the embodiment of FIG. 4, the clamp-like retaining element 15 is designed as a separate component that can be detached from the cable channel.

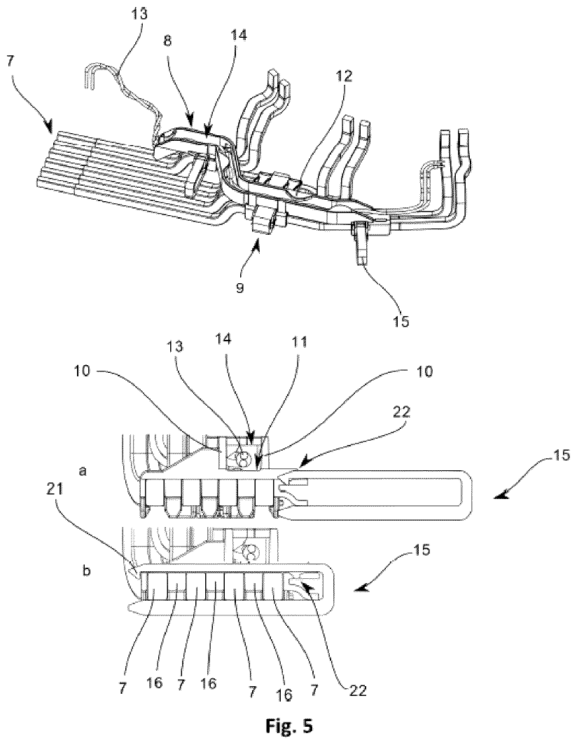

However, it is also conceivable that, for reasons of security against loss, the clamp-like retaining element 15 is designed to be captively connected to the cable channel 8, as shown by way of example in FIG. 5. In the lower illustration of FIG. 5, designated with a, the retaining element 15 is shown in a first assembly position in which the retaining element 15 is engaged with its latching lug in a corresponding locking means 22 of the cable channel 8. From this first mounting position, the retaining element 15 can then be moved into a second mounting position by sliding it transversely to the longitudinal extent of the cable channel 8, which can be seen in the illustration marked b in FIG. 5.

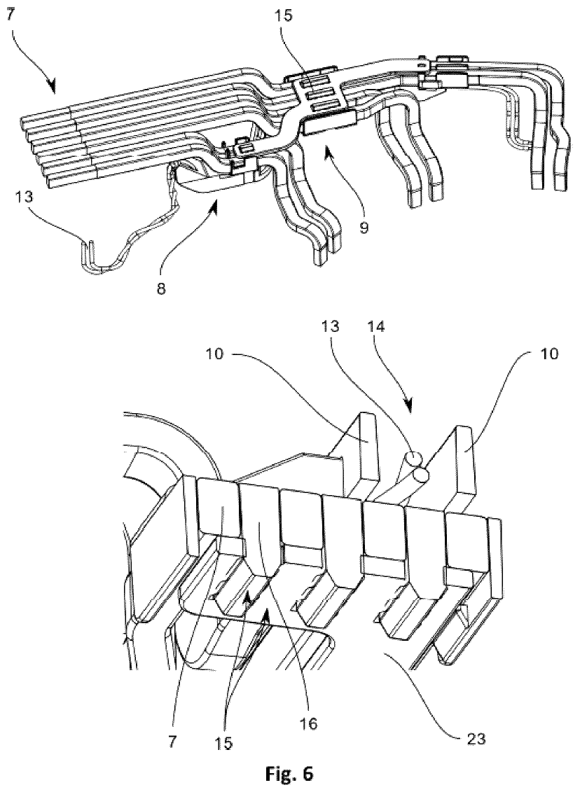

Another option for designing the retaining element 15 is shown in FIG. 6. Here, latching hooks, not further designated, are provided at the distal, free ends of the busbar spacer elements 16, which together with a latching plate 23 form the retaining element 15. For this purpose, the latching plate 23 is then placed on the cable channel 8 so that the latching hooks snap into the openings provided for this purpose in the latching plate 23.

Finally, FIG. 7 shows an embodiment of the cable channel 8 in which the retaining element 15 is formed monolithically with the busbar spacer element 16. In this case, a retaining element 15 is arranged on the free end 17 of the busbar spacer element 16, that engages behind and/or around two adjacent busbars 7 at least in sections, so that the cable channel 8 is held securely against the busbars 7. The retaining element 15 was formed by hot caulking the busbar spacer element 16. This can be done, for example, by pressing the busbar spacer elements 16 with a counter-plate after the cable channel 8 has been placed on the busbars 7.

The disclosure is not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define ‘first’ and ‘second’ features, this designation serves to distinguish between two features of the same type without defining an order of precedence.

### LIST OF REFERENCE SYMBOLS

1 Stator
2 Electric machine
3 Drivetrain
4 Motor vehicle
5 Stator element
6 Winding
7 Busbars
8 Cable channel
9 Busbar fixing means
10 Channel side walls
11 Channel base
12 Cable clamps
13 Cable
14 Opening cross-section
15 Retaining element
16 Busbar spacer element
17 End
18 Temperature sensor
19 Power electronics unit
20 Control unit
21 Latching lug
22 Locking means
23 Latching plate

1. A stator of an electric machine of a motor vehicle comprising:
a stator element having an energizable winding which is electrically conductively connected to a plurality of busbars extending outside the stator element, wherein
a cable channel formed from electrically nonconductive plastics material is arranged on the busbars and has at least one busbar fixing element by which the cable channel is fixed to the busbars and a position of the busbars relative to one another is fixed.

2. The stator according to claim 1, wherein
the cable channel has a substantially U-shaped contour in cross-section with two parallel channel side walls and a channel base.

3. The stator according to claim 2, wherein
at least one cable clamp is arranged on at least one of the channel side walls, which secures a cable extending in the cable channel against exiting the cable channel by narrowing an opening cross-section of the cable channel at least in sections.

4. The stator according to claim 1, wherein
the at least one busbar fixing element has at least one busbar spacer element, against which two adjacent busbars rest and which is formed integrally with the channel base and extends out of the channel base in a direction of the busbars.

5. The stator according to claim 1, wherein
the channel base rests on the busbars.

6. The stator according to claim 4, wherein
a retaining element is arranged on a free end of the busbar spacer element, that engages at least behind or around the two adjacent busbars at least in sections, so that the cable channel is held securely against the busbars.

7. The stator according to claim 6, wherein
the retaining element is formed integrally with the busbar spacer element.

8. The stator according to claim 7, wherein
the retaining element is formed by hot caulking the busbar spacer element.

9. The stator according to claim 6, wherein
the at least one busbar fixing element comprises a separate retaining element.

10. The stator according to claim 1, wherein
the cable channel has a Z-like course in a longitudinal extension thereof.

11. A cable channel for a stator of an electric machine of a motor vehicle, the electric machine having a stator element with an energizable winding which is electrically conductively connected to a plurality of busbars extending outside the stator element, the cable channel comprising:
an electrically nonconductive plastic material body including at least one busbar fixing element by which the cable channel is fixable to the busbars and a position of the busbars relative to one another is fixed by the cable channel.

12. The cable channel according to claim 11, wherein the cable channel has a substantially U-shaped contour in cross-section with two parallel channel side walls and a channel base.

13. The cable channel according claim 12, wherein at least one cable clamp is arranged on at least one of the channel side walls, which secures a cable extending in the cable channel against exiting the cable channel by narrowing an opening cross-section of the cable channel at least in sections.

14. The cable channel according to claim 11, wherein the at least one busbar fixing element has at least one busbar spacer element, against which two adjacent busbars can rest and which is formed integrally with the channel base and extends out of the channel base in a direction of the busbars.

15. The cable channel according to claim 11, wherein the channel base rests on the busbars.

16. The cable channel according to claim 14, wherein a retaining element is arranged on a free end of the busbar spacer element, for engaging at least behind or around the two adjacent busbars at least in sections, so that the cable channel can be held securely against the busbars.

17. The cable channel according to claim 16, wherein the retaining element is formed integrally with the busbar spacer element.

18. The cable channel according to claim 17, wherein the retaining element is formed by hot caulking the busbar spacer element.

19. The cable channel according to claim 16, wherein the at least one busbar fixing element comprises a separate retaining element.

20. The cable channel according to claim 11, wherein the cable channel has a Z-like course in a longitudinal extension thereof.
